(19) United States
(12) Patent Application Publication
(10) Pub. No.: US 2012/0037717 A1
(43) Pub. Date: Feb. 16, 2012

(54) DISPERSING DEVICE, ITS USE AND CORRESPONDING METHOD FOR PULVERIZED SPREADING A PHYSICAL AGENT

(76) Inventor: Vladimir Dmitry Zakhmatov, Kiev (UA)

(21) Appl. No.: 13/129,082

(22) PCT Filed: Nov. 12, 2008
(86) PCT No.: PCT/EP2008/065340

§ 371 Date: Nov. 3, 2011

(51) Int. Cl. B05B 15/00

(52) U.S. Cl. 239/1; 239/289

(57) ABSTRACT

A dispersing device (10) for spreading a physical agent (2), comprising a container (1) for receiving the agent (2), the container (1) having an exit side (7) through which the physical agent (2) is to be released and an interface (8), a chamber (9) for receiving a weak detonating explosive (6), the chamber (9) having a chamber exit (11) being connectable to the container (9) via the interface (8), wherein the interface (8) provides for a transition extending a cross-section of the chamber exit (11) to a cross-section of the container (1). The dispersing device (10) provides for a transformation of a pressure wave created by the weak detonating explosive (6) into a pressure wave travelling through the physical agent (2), a mixing of exhaust by-products with the physical agent (2) and also provides for a pulse pulverization of the agent (2) upon release through said exit side (7).

### FIELD OF THE INVENTION

The present invention relates to a dispersing device for spreading a physical agent, the use of said dispersing device and a method for spreading a physical agent using such a dispersing device.

### BACKGROUND OF THE INVENTION

A quick, even pulverized spreading of an agent has long been an issue in several fields of activity. Some of these fields are firefighting, explosive prevention, localization and confinement of toxic chemicals or radioactive material, cleaning of oil spreads on water surfaces, heat protection, camouflage or crowd/terrorist control. A common problem has been that in order to ensure a proper effect and to achieve a sufficiently even coverage, very often a much larger amount of agent has been used. Obviously this leads to a significant amount of waste of the agent. Even though in many cases the price of the agent is negligible, the time and cost to produce, deliver, prepare for use and distribution of it is significant. Thus the use of unnecessary agent just to ensure that the entire area is covered with at least some of the agent leads to serious disadvantages. Not only significant amounts of agent are wasted, but in many cases an excess of said agent may cause further damages.

For example if some sort of decontaminant needs to be spread evenly on a large surface, if one uses classical means for said spreading there is a constant danger that either spots are missed, or if this is avoided by an excess of agent, some areas might be overdosed. If used in large amounts even weak chemicals might cause serious damages. Additionally, some decontaminants can be very expensive, so an optimal use is critical.

A further example is firefighting, where usually a larger amount of agent, i.e. water, foam, etc., is spread in order to ensure that the entire burning surface is covered and no spots are missed. However, the effectiveness of the water usage can be as low as 3%. A side effect of this is that in many cases, even though the fire is successfully extinguished, the affected property (building, vehicle, etc) is completely soaked and a significant part of the damage is caused by the fire extinguishing agent itself. It has been reported numerous times that even if a burning building has been relatively quickly extinguished, it had to be demolished since the excess water has weakened the structure of the building making it unsafe. A further danger firefighters have to face is electrocution. It is statistically proven that a very high percentage of all fires are caused by electricity. However, firefighters often can not intervene due to the high risk of electrocution. Often critical time is lost until the area is disconnected from all power sources.

In case of forest fires and such extended areas, the vast surface that needs to be covered with a fire extinguishing agent makes the waste of these agents even more severe. Since very often forest fires occur in remote and/or dry areas the mere task of providing sufficient amount of fire extinguishing agent, quite often water, is difficult or even impossible. Thus the efficient use of the resources available is essential.

An other field where a very thin but even coverage is a requirement is the confinement/treatment of water pollution such as oil spills. Confinement and treatment of water contamination usually involves large surfaces of open water which need to be treated fast and thorough. There are two stages of such disaster relief efforts: confinement and treatment. In first step the pollution has to be somehow confined in order to prevent the contamination of further areas. In a second stage, the area affected has to be treated. The even spreading of an agent has to be done for both stages but comes into play essentially in the second stage when some sort of biosorbent has to be spread on the contaminated water surface. An even coverage of the surface with such biosorbents will ensure a proper decontamination of the area allowing a quick recovery of the local ecosystem. However, an exaggerated use of these biosorbents by excessive coverage can cause even more damage to the ecosystem heavily affecting the quality of water and the natural habitat. Furthermore, the price of these agents and the high amount needed to cover extended surfaces ask for an effective and precise method for spreading said agent that can minimize the amount needed but at the same time ensure that the entire surface is covered.

In crowd control, a quick but controlled deployment of smoke, tear gas, pepper spray, sticky foam, or other incapacitants is essential. At the same time an overdose, i.e. an inadequate concentration of these agents might cause serious injuries leading to moral and/or legal issues.

The objective of the present invention is thus to provide a dispersing device and a corresponding method which enable a quick but uniform distribution of a physical agent while at the same time minimizing the amount of agent required without compromising the uniformity of the coverage.

A further object of the present invention is to provide a dispersing device that is easy and cheap to produce, with high versatility suitable for spreading a wide range of agents in an effective manner.

An even further objective is to provide a dispersing device that is easy to use and which is at the same time also reusable to minimize cost and waste.

A further objective of the present invention is to provide a dispersing device that is scalable and customizable for specific deployment areas.

### SUMMARY OF THE INVENTION

The above-identified objects are solved by the present invention by a dispersing device according to claim 1 for spreading a physical agent providing for a so-called pulse-pulverization of the agent as said agent is released through an exit side of said dispersing device by a pressure wave travelling through said agent, said pressure wave being caused by an activation of a weak detonating explosive and also providing for a mixing of exhaust by-products created by said weak detonating explosive when activated with the physical agent.

A combined effect of

a mixing of exhaust by-products created by said weak detonating explosive when activated with the physical agent,

said pulse pulverization of said physical agent upon release

and of the transformation of a pressure wave created by said weak detonating explosive when activated into a pressure wave travelling through said physical agent

together create a so-called gasdispersive pressure vortex that ensures a universal, effective pulverization on long distances, large areas and high volumes of the various agents.

According to the present invention, said physical agent can be any one or a combination of the following: different liquids, gelatin, dictilate plastic, dense solutions, viscous materials, powders, sand or other granular material, snow, foam, dry or wet fire extinguisher chemicals, biosorbents, incapacitants, radioactivity neutralizing particles, etc.

Further advantageous embodiments of the present invention are defined in dependent claims 2 to 11.

The dispersing device of the present invention, by employing one of the above-enlisted agents finds its use in various fields according to use claims 12 to 26.

Said objectives of the present invention are further solved by a method for pulse-pulverizing and spreading a physical agent according to claim 27, wherein a pressure wave is created by an activation of a weak detonating explosive. The pressure wave which by traveling through said physical agent causes it to mix with exhaust by-products created by said weak detonating explosive and also causes its pulse pulverization and release through an exit side of the dispersing device.

Further advantageous methods according to the present invention are described in dependent method claims 28 to 32.

The main advantage of the present invention is that an efficient spreading of the physical agent is possible thus minimizing the amount of agent needed for a uniform coverage of a surface of choice.

Generally, the cheap and easy production of the present invention makes this dispersing device widely accessible and due to its versatility it can be used for various purposes. Another advantage of the present invention is that the dispersing device is completely scalable, i.e. its size and capacity can be varied freely without the need to modify the basic design at all. On the other hand the system can be built in a modular arrangement, i.e. an array or set of dispersing devices of the present invention can be joined to build a system where multiple pulverizing shots can be performed one after the other or at the same time without the need for refilling.

Further advantageous effects of the present invention are related to one or more of the following fields of applicability:
in firefighting, the present invention allows a quick and efficient spreading of any fire-extinguishing agent accompanied by the so-called gasdispersive pressure vortex which provides for instantaneous extinguishing of the fire;
when used for confinement of toxic chemicals or radioactive materials, the agent (a decontaminant or radioactivity neutralizing particles) can be spread evenly on extended surfaces without neither missing spots nor requiring the use of excess agent, which might cause further damage to the contaminated surface (soil, water, etc);
when used for camouflage or crowd control purposes, the dispersing device or method of the present invention allows a quick and controlled deployment of smoke, tear gas, pepper spray, sticky foam, or other irritants and incapacitants allowing fast intervention while eliminating the danger of abusive overuse causing injuries. Furthermore, pulverization of natural materials such as water, sand, dust, soiled water, gelatins, snow or ice might be effective for these purposes as well.

### BRIEF DESCRIPTION OF THE DRAWINGS

Further characteristics and advantages of the invention will in the following be described in detail by means of the description and by making reference to the drawings. Which show:

FIG. 1 A structural side-view of a first embodiment of the dispersing device according to the present invention;

FIG. 2 A structural side-view of an alternative embodiment of the dispersing device according to the present invention;

FIG. 3 A structural side-view of a symmetrical two-sided embodiment of the dispersing device according to the present invention;

FIG. 4 A structural side-view of a further embodiment of the dispersing device for home/personal use according to the present invention comprising a recoil damper arrangement;

FIG. 5 A symbolic view of the dispersing device according to the present invention as being used for amateur home/personal firefighting;

FIG. 6 A symbolic view of a remotely controlled arrangement of dispersing devices according to the present invention as being used for extinguishing a fire in a high-rise building from outside as being suspended from a helicopter;

FIG. 7 A symbolic view of the dispersing device according to the present invention as being used for camouflaging or crowd control purposes;

FIG. 8 A symbolic view of the dispersing device according to the present invention as being used for spreading an agent across a water surface for treating contaminated water.

### DESCRIPTION OF PREFERRED EMBODIMENTS

The term activation will be used in the context of the present application with the meaning of some sort of action causing a detonation, ignition, etc of an explosive or deflagrating gun powder. Generally speaking, activation will cause said explosive or deflagrating gun powder to detonate/deflagrate and create a pressure wave as a result of said detonation/deflagration. The activation can be by an electric detonator, a mechanical detonator, a simple fuse or other known means used in the field to detonate an explosive material.

The term weak detonating explosive is being used in the context of the present application to refer to any type of explosive or deflagrating material that is suitable to create a pressure wave when activated.

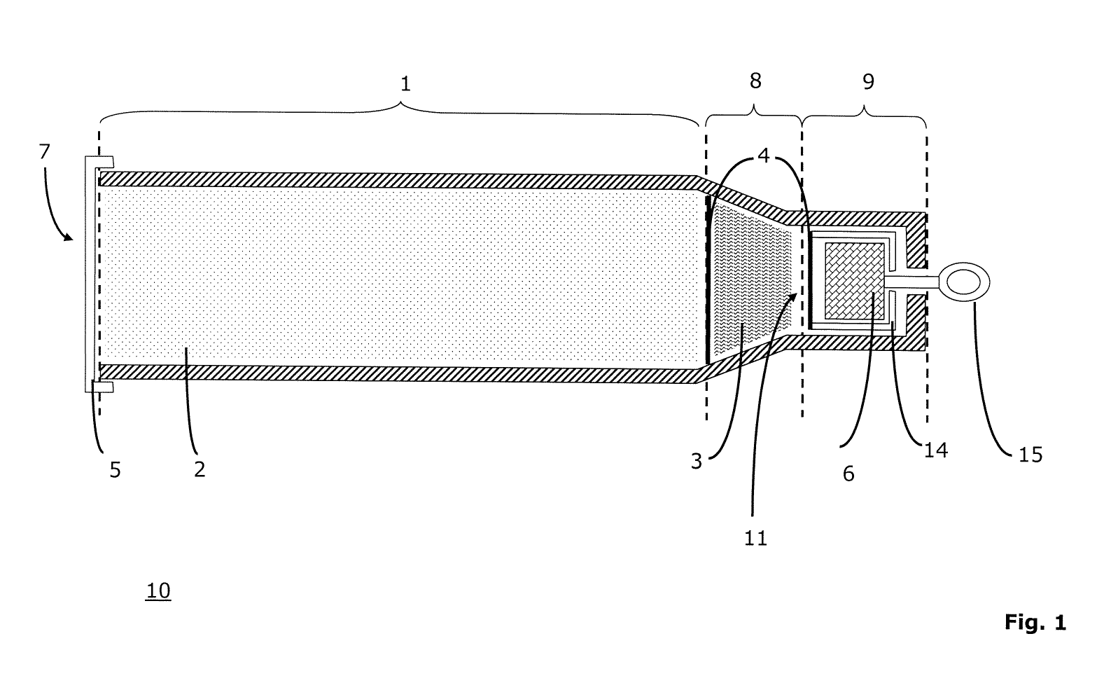

FIG. 1 shows the basic embodiment of the present invention which in this arrangement is a multi-purpose device, i.e. it could be used with little or no modification for any of the above-enlisted purposes.

The main body of the dispersing device 10 is a container 1 for receiving the physical agent 2 that is to be spread with the dispersing device 10. This container 1 is usually a longitudinal enclosing suitable for receiving considerable amounts of said physical agent 2. The container 1 can be made of literally any material sufficiently strong to withstand the destructive force of a small detonation, caused by a weak detonating explosive 6 to be described in detail later. A common requirement of the material used for producing the container 1 is for it to be available in relatively large quantities, to be relatively cheap and easy to shape/produce. Depending on the size and application of the dispersing device 10, the container 1 can thus be made of various plastics such as PET (polyethylene terephthalate), different lightweight metals or even composite materials. The container 1 has a wall which in different applications can be provided with special textures/grooves thus facilitating a more efficient creation of a so-called “gasdispersive pressure vortex” to be discussed later. The surface of the wall itself can play a significant role depending on the physical agent 2 used.

On one end, the container 1 has an exit side 7 through which said physical agent 2 is to be released. This exit side 7 can be in some cases an opening of the container 1 leaving the physical agent 2 provided in the container 1 exposed, or said exit side 7 can be a section of the container 1 which can disintegrate/open/break due to the pressure wave caused by said detonation. In the first case, where the physical agent 2 provided in the container 1 exposed, the exit side 7 is usually provided with a cover 5. The main role of this cover 5 is to make sure that no physical agent 2 can fall out of the dispersing device 10 during transportation, handling or anytime before its use. However, in some cases this cover 5 also serves as a protection against accidental exposure to the physical agent 2. This is especially the case when the physical agent 2 is a strong chemical agent.

This cover 5 is usually a lightweight and cheap part, which is designed most of the times for one time use, i.e. after each use of the dispersing device 10, this cover 5 is destroyed or propelled away. In certain cases one might be able to find the cover 5 laying somewhere around and reuse it, but the low price and one-time use design of the cover 5 make a search for the used cover 5 unnecessary. The cover 5 may be connected to the container 1 by means of a cable or by a piece of string.

Probably the most important and various aspect of the present inventions is the physical agent 2 which fills the container 1 described above. This physical agent 2 can be, depending on application, a liquid such as water, dense/viscous/sticky/powdered/granular/mixed or natural-ground material, mud, sand, snow, ice and many other suitable materials. These materials can further be doped with different chemicals depending on application. For fire-fighting applications, the physical agent 2 comprises water, fire-extinguishing foam, sand, mud, snow, or other fire-suppressing materials. For contamination-treatment applications, the physical agent 2 comprises biosorbents such as microorganisms or biological agents to break down or remove said contamination, or in case of nuclear contamination treatment, different radioactivity neutralizing particles. For crowd-control applications said physical agent 2 contains non-lethal agents such as tear gas, pepper spray, sticky foam, various irritants, or other incapacitants. When the dispersing device 10 is used for camouflage purposes, the physical agent 2 comprises some sort of loose opaque agent. Furthermore, pulverization of natural materials such as water, sand, dust, soiled water, gelatins, snow or ice might be effective for these purposes as well.

As shown in FIG. 1, the dispersing device 10 further comprises a chamber 9 for receiving a weak detonating explosive 6. This chamber 9 can be an integral part with the container 1 or completely separate. The role of this chamber 9 is to accommodate the weak detonating explosive 6 and provide for a detonation chamber, so that when the weak detonating explosive 6 is activated, the pressure wave created by said detonation is directed towards a chamber exit 11 of this chamber 9. Usually, the chamber 9 part is made stronger than the container 1 part since the chamber 9 has to withstand greater pressures when the weak detonating explosive 6 is activated.

This chamber 9 is provided with a weak detonating explosive 6 which can be activated in order to create a pressure wave as a result of its detonation. This weak detonating explosive 6 can be various types of explosives, such as black powder, trinitrotoluene, hexogen pulverized in porous thick material or deflagrating gun-powder for example. In the preferred embodiment of the present invention the weak detonating explosive 6 is chosen so that the pressure wave created by the weak detonating explosive 6 when activated is travelling at a speed between 1000 and 3000 m/s.

In the preferred embodiment of the present invention, the weak detonating explosive 6 is provided in a replaceable cartridge 14. This way the weak detonating explosive 6 is safely protected in said cartridge 14, minimizing the danger of said weak detonating explosive 6 leaking out or being exposed in some way. The use of a cartridge 14 to hold the weak detonating explosive 6 makes the recharging, i.e. refitting the dispersing device 10 with a new load of weak detonating explosive 6 after its use, a lot faster and easier step. This is especially preferred when the dispersing device 10 is to be used repeatedly. Thus instead of replacing the entire dispersing device 10 for a repeated use, one only needs to insert a new cartridge 14 with weak detonating explosive 6 into the chamber 9. This step can thus be carried out even by the user itself without any tools or special knowledge. Additionally, this cartridge 14 along the weak detonating explosive 6 also comprises an igniter 15 capable of activating said weak detonating explosive 6. In some embodiments, such as the one on FIG. 1, said igniter 15 is connected to a manual igniter ring which can be manually triggered thus causing the activation of the weak detonating explosive 6. This igniter ring is usually employed in connection with a mechanical detonator.

According to the preferred embodiment of the present invention, the ratio of the physical agent 2 and the weak detonating explosive 6 is preferably between 1/50 up to 1/500 in certain cases. The aforementioned ratio is valid for all embodiments described and presented herein.

The dispersing device 10 also comprises an interface 8 providing for a transition extending a cross-section of said chamber exit 11 to a cross section of said container 1. Said cross section of the container 1 is larger than the cross section of the chamber exit 11. This way the pressure wave created by an activation of the weak detonating explosive 6 is distributed on a larger surface creating a wave travelling through a large amount of physical agent 2.

In certain embodiments, the interface 8 is designed so, that commonly used receptacles can be used as a container 1 thus eliminating the need of producing custom-made containers 1. For example, PET soft-drink bottles can be used as a container 1 with an interface 8 designed to accommodate these. A further advantage of using commonly available receptacles as a container 1 is that these are easily available in large quantities almost anywhere, thus reducing the intervention time in some cases.

It is to be observed, that in some of the cases the container 1, the interface 8 and the chamber 9 will be formed by one single piece designed so that it can perform all functions of each separate part, i.e. the chamber 9 is strong enough to withstand the force of the detonation, the interface 8 is shaped so that pressure wave is transformed as needed and the container 1 part is suitable for receiving and then releasing sufficient amounts of the physical agent 2.

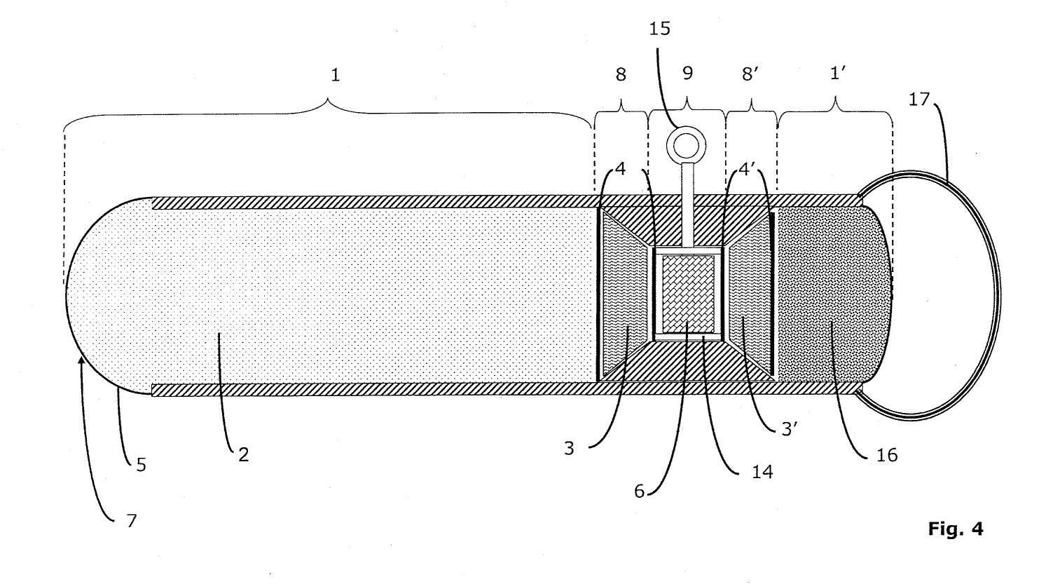

However, in some cases it is preferred that the container 1, the interface 8 and the chamber 9 to be separate parts so that each can be replaced/removed separately. This is preferred for example when the container 1 is delivered ready-to use, i.e. filed with the physical agent 2, and need only be attached to the rest of the dispersing device 10 to be used. An other case where a modular arrangement is advantageous is when the weak detonating explosive 6 comes readily built in the chamber 9 part. A further preferred embodiment of this type will be discussed in relation to FIG. 4 as well.

The arrangement of the container 1, the interface 8 and the chamber 9 as described above provides for a transformation of the pressure wave created by said weak detonating explosive 6 when activated into a pressure wave traveling through said physical agent 2. It is to be emphasized that the pressure wave travels through the physical agent 2 as opposed to prior art dispersing devices, where the physical agent 2 is propelled/ejected by said pressure wave but said pressure wave does not travel through the physical agent 2. The effect of said pressure wave travelling through the physical agent 2 is that the physical agent 2 is pulse-pulverized upon release through said exit side 7. Additionally, the exhaust by-products created by the weak detonating explosive 6 when activated, are fully mixed with the physical agent 2 and are also pulse-pulverized together with it. This combined effect creates a so-called gasdispersive pressure vortex that ensures a universal, effective pulverizing on long distances, large areas and high volumes. It is to be observed that special arrangement of the container 1, the interface 8 and the chamber 9 as described above further provides a cooling effect of said exhaust by-products before they are being mixed with the physical agent 2.

A further embodiment of the present invention comprises a porous wad 3 for transforming a short energy pulse created by an activation of said weak detonating explosive 6 into a longer-lasting energy pulse applied onto said agent. This transformation further aids the pulse-pulverization of the physical agent 2 providing for an effective spreading of it. The porous wad 3 can be made of various porous materials such as porolon, polyurethane foam and other foam-type substances. A gelatin wad or a porous wad filled with some liquid may also be used as porous wad 3.

In an even further embodiment of the present invention, the interface 8 is provided with an elastic film 4 for distributing the pressure wave, created by the activation of the weak detonating explosive 6, evenly across said cross-section of the container 1. In an even further embodiment of the present invention, the weak detonating explosive 6 itself is also enclosed by a further elastic film 4. The elastic film 4 can be made of various porous materials such as polyethylene, polyvinyl chloride, polypropylene and other suitable materials.

In the preferred embodiment of the present invention, if a porous wad 3 and/or an elastic film 4 is provided, these are usually consumed each time the dispersing device 10 is used, i.e. each time a pressure wave created by the activation of the weak detonating explosive 6 travels through the dispersing device 10. For this reason said porous wad 3 and/or elastic film 4 are made of cheap, easily replaceable materials and are usually integral parts of a replaceable container 1 or interface 8.

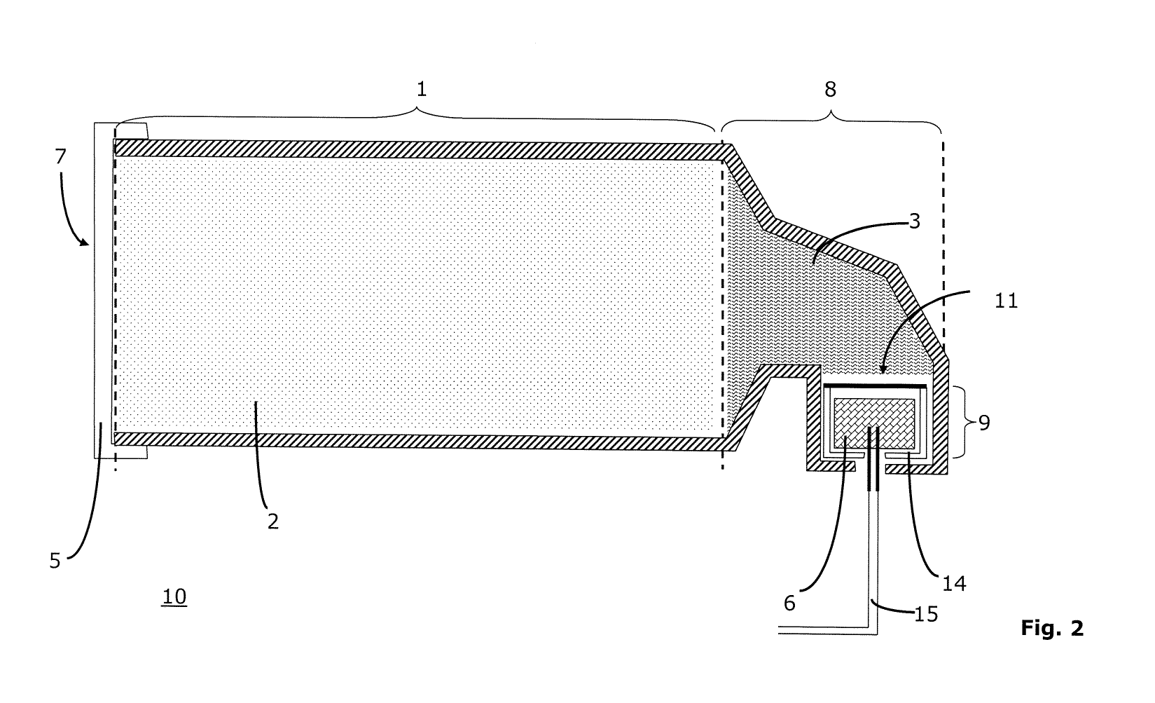

An alternative embodiment of the present invention is shown on FIG. 2, where the interface 8 not only provides a transition extending a cross-section of said chamber exit 11 to a cross section of said container 1 but also provides a 90 degree deviation of the pressure wave created by the activation of the weak detonating explosive 6. This arrangement is especially suitable for automated, permanent installations in order to save space and to enable an easy installation.

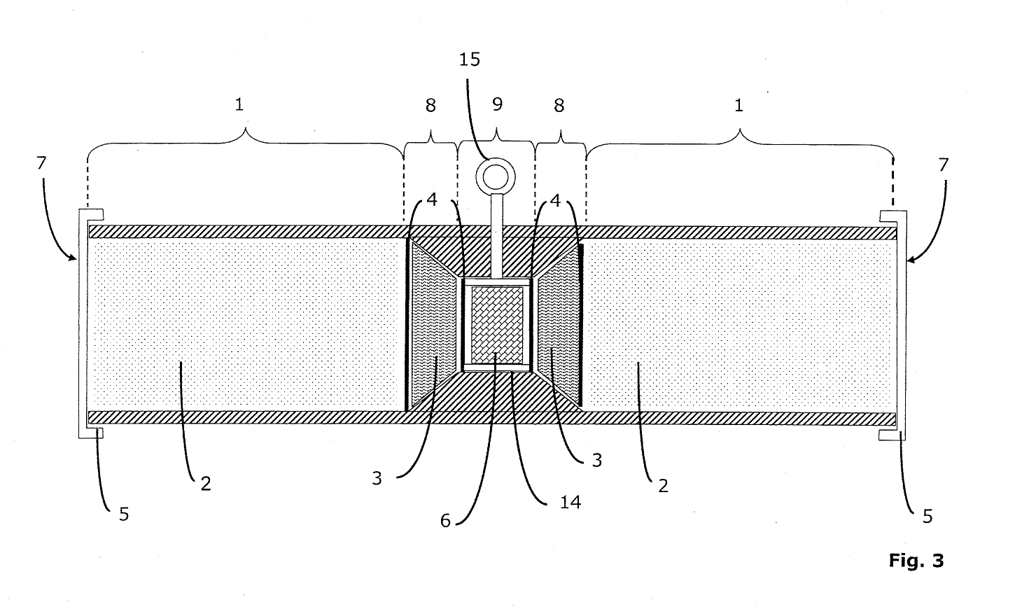

An even further embodiment of the present invention is depicted on FIG. 3, showing a symmetrical arrangement of the dispersing device 10. In this embodiment, the chamber 9 with the weak detonating explosive 6 is located essentially in the middle of the dispersing device 10 with a pair of interfaces 8 and containers 1 symmetrically extending to the sides. Accordingly, the dispersing device 10 is fitted with not only one but with a pair of porous wads 3, elastic films 4, exit sides 7 and covers 5. Furthermore, both containers 1 are filled with the same or different physical agents 2. We must emphasize though that only one single chamber 9 with a weak detonating explosive 6 and one single igniter 15 is provided. Thus an activation of the weak detonating explosive 6 causes the physical agent 2 in both containers 1 to be forced out of the containers 1 through the exit sides 7 and pulse pulverized in opposite directions.

This embodiment is especially suitable for firefighters who have to pass a fire very quickly, for example to rescue someone, without having time to extinguish the entire fire first. In this case the dispersing device 10 is held horizontally and thus a free corridor can be created on the sides for the firefighters to pass. A similar principle applies when one must pass through a contaminated cloud or nuclear fallout or other contaminated dust cloud.

The symmetrical principle can be further extended into a multidirectional embodiment, where multiple arrangements, each comprising an interface 8, a container 1 and eventually a porous wad 3, an elastic film 4 and a cover 5, are assembled around one single chamber 9 with one single weak detonating explosive 6 and igniter 15. A three-directional embodiment might be for example needed when a firefighter needs to pass through a fire that burns from the ceiling as well thus requiring a pulse-pulverized extinguishing not only to the sides but towards the ceiling as well in order to ensure safe passage.

FIG. 4 shows a further embodiment of the present invention specially designed for personal/home use. For this purpose, the dispersing device 10 further comprises a second container 1′ filled with heavy granular material 16. The second container 1′ is positioned on an opposite side of the chamber 9 as the container 1 with the physical agent 2. The second container 1′ is connected to the chamber 9 via a second interface 8′ similar to the interface 8 having a similar purpose, i.e. to provide a transition extending a cross-section of a second chamber exit 11′ to a cross section of said second container 1′. The heavy granular material 16 has the role of absorbing the recoil forces due to the activation of the weak detonating explosive 6. Additionally, an elastic recoil damper 17 is also fitted on the other end of the second container 1′ as to where the second interface 8′ is fitted. This recoil damper 17 is provided to further damp the recoil forces due to the activation of the weak detonating explosive 6 by absorbing sufficient amounts of energy by elastic deformation. The recoil damper 17 has the shape of a hemisphere attached to the end of the second container 1′ forming an open cavity between the heavy granular material 16 and its inner wall. When the weak detonating explosive 6 is activated, this inner cavity of the recoil damper 17 also acts as a means for confining and preventing the release of the heavy granular material 16. According to the intended use of the dispersing device 10, the recoil damper 17 is pressed against the user's chest/shoulder, etc. and when the weak detonating explosive 6 is activated, the elastic deformation of the recoil damper 17 prevents the dispersing device 10 of causing injuries to the body part pressed against. The fact that the dispersing device 10 is pressed against one's chest/shoulder ensures that the dispersing device 10 is firmly held and can not go out of control, despite the detonation of the weak detonating explosive 6. Occasionally, this embodiment is fitted with a second porous wad 3′ and/or a second elastic film 4′ providing with the same function as the porous wad 3 or elastic film 4.

FIG. 4 shows a further feature wherein said exit side 7 is not open but is a section of the container 1 which is produced thinner or from a weaker material than the rest of the container 1 allowing this part to disintegrate/open/break due to the pressure wave caused by the activation of the weak detonating explosive 6. The respective part of the container 1 may also comprise predetermined breaking points or lines.

The interface 8 of the embodiment shown on FIG. 4 can be adapted so that common receptacles can be used as a container 1 thus eliminating the need of producing custom-made containers 1. For example, PET refreshment bottles can be used as a container 1 with an interface 8 designed to accommodate these. An advantage of using commonly available receptacles as a container 1 is that these are easily available in large quantities almost anywhere. In this case, a cover 5 is not provided, instead the exit side 7 being integral part of the PET bottle is broken apart by the pressure wave thus enabling the release of the physical agent 2.

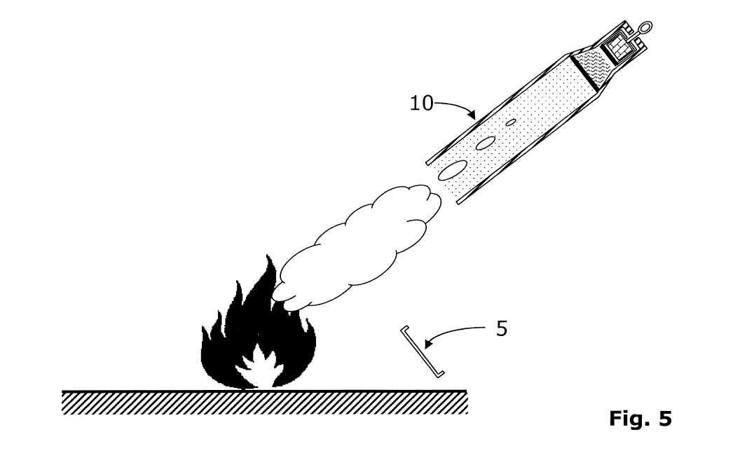

FIG. 5 shows the dispersing device 10 as used for firefighting. In a first step a dispersing device 10 according to the present invention has to be provided. The container 1 has to be filled with a suitable fire-extinguishing physical agent 2, and a weak detonating explosive 6 has to be installed. Then the dispersing device 10 has to be directed with its exit side 7 towards the burning surface/fire and the weak detonating explosive 6 has to be activated, preferably by means of the igniter 15. Thus a pressure wave travelling through said physical agent 2 is created also providing for a mixing of exhaust by-products produced by said activation and the mixture is then pulse-pulverized and released through the exit side 7 thus extinguishing the fire. As shown on FIG. 5, the cover 5, if one is provided, is usually ejected by the pressure wave. It is to be noted, that not only the physical agent 2 covering the burning surface extinguishes the fire, but the combined effect of the mixing of exhaust by-products, pulse pulverization of said physical agent upon release and of the transformation of a pressure wave created by said weak detonating explosive when activated into a pressure wave travelling through said physical agent which together create a so-called gasdispersive pressure vortex.

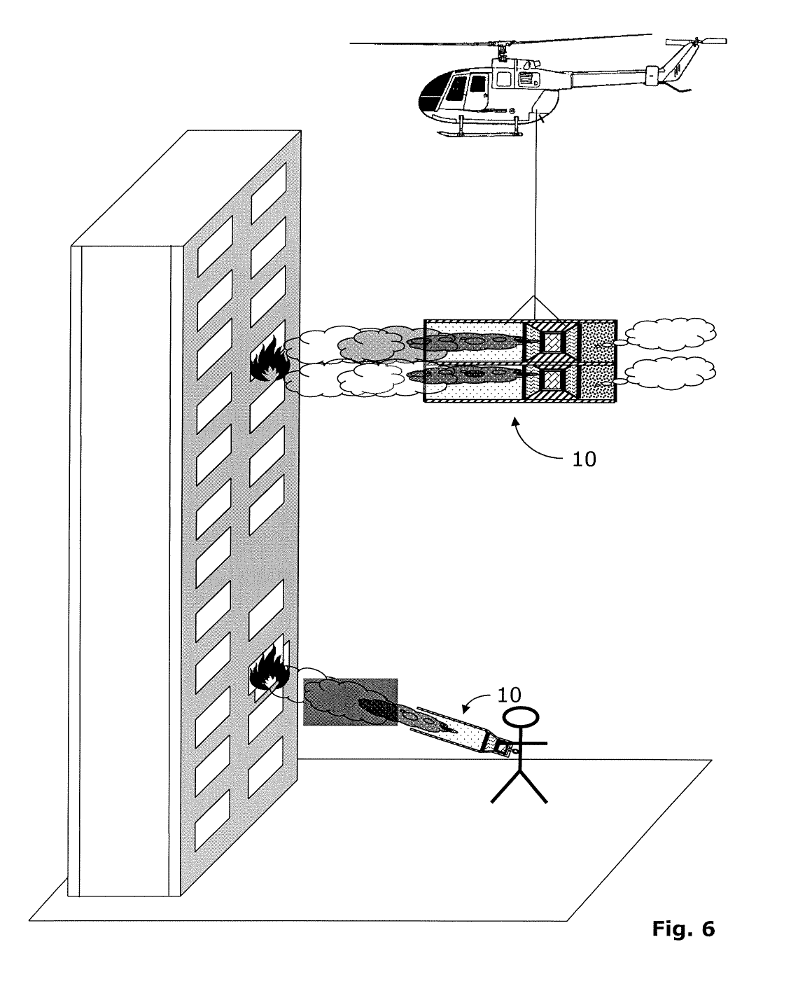

FIG. 6 shows the use of the dispersing device 10 for extinguishing a fire in a high-rise building. The dispersing device 10 (not drawn to scale) is suspended from a helicopter and raised to the level of the fire outside the building and spaced a sufficient distance apart. As shown on FIG. 6, multiple dispersing devices 10 may be bundled together to increase the extinguishing capacity. Not shown on FIG. 6 is the possibility of sing a crane for lifting the dispersing device 10 or the bundle of dispersing devices 10 to the level of the fire.

The weak detonating explosive 6 of the dispersing device 10 is then remotely activated causing the physical agent 2 to be pulse-pulverized and propelled in the direction of the fire. This use is particularly advantageous since no direct human intervention is required, thus minimizing the risk of injury of the firefighters.

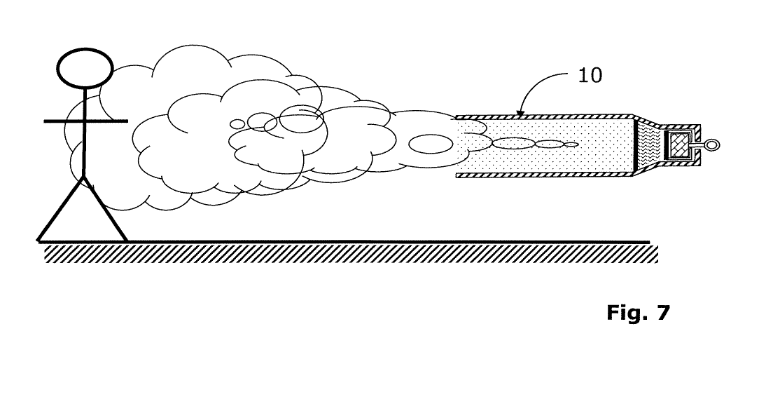

The use the dispersing device 10 for camouflage and/or crowd-control purposes is shown on FIG. 7. In this case the container 1 of the dispersing device 10 is filled with a very light and loose, non-lethal physical agent 2 aimed to cause discomfort and/or reduce visibility of the targeted person. The physical agent 2 in these applications is one or a combination of non-lethal agents such as tear gas, pepper spray, sticky foam, or other incapacitants. When the dispersing device 10 is used for camouflage purposes, the physical agent 2 comprises some sort of loose opaque agent.

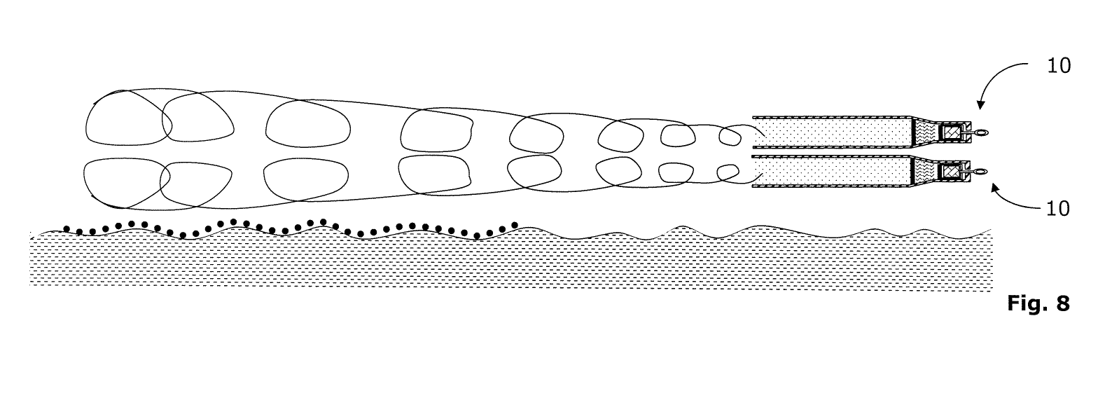

FIG. 8 shows a pair of dispersing devices 10 as being used to treat a contaminated water surface. Testing has shown that in such applications a pair of the dispersing devices 10 performs much better due to a combined effect of opposite gasdispersive pressure vortexes. The pair of dispersing devices 10 is configured so, that the vortexes whirl in opposite directions thus providing for an increased dispersive effect ensuring a more efficient coverage. For this application the physical agent 2 comprises biosorbents such as microorganisms or biological agents to break down or remove the contamination.

It will be understood that many variations could be adopted based on the specific structure hereinbefore described without departing from the scope of the invention as defined in the following claims.

### REFERENCE LIST

dispersing device 10
container 1
second container 1′
physical agent 2
porous wad 3
elastic film 4
cover 5
weak detonating explosive 6
exit side 7
interface 8
second interface 8′
chamber 9
chamber exit 11
second chamber exit 11′
cartridge 14
igniter 15
heavy granular material 16
recoil damper 17

1-33. (canceled)

34. A dispersing device for spreading a physical agent, comprising:
a first container adapted to receive a physical agent and having an exit side including an exit and a first interface;
a chamber adapted to receive a weak detonating explosive and having a chamber exit connectable to said container by the first interface, wherein the first interface comprises a transition extending from the cross-section of the chamber exit to the cross-section of the first container;
a second container including a heavy granular material therein and located on a side of the container opposite the weak detonating explosive;
a second interface; and
a recoil damper configured to damp recoil caused by an activation of the weak detonating explosive;
wherein the dispersing device is configured to:
transform a pressure wave created by said weak detonating explosive when activated into a pressure wave traveling through said physical agent;
mix exhaust by-products created by the weak detonating explosive when activated with the physical agent; and
pulse pulverize the physical agent upon release of the physical agent through the first container exit side.

35. A dispersing device as defined in claim 34, wherein the chamber comprises a porous wad adapted to transform a short energy pulse created by said weak detonating explosive into a longer-lasting energy pulse applied to the physical agent.

36. A dispersing device as defined in claim 34, wherein the first interface includes an elastic film adapted to evenly distribute the pressure wave created by the activated weak detonating explosive across the cross-section of the first container.

37. A dispersing device as defined in claim 35, wherein the first interface includes an elastic film adapted to evenly distribute the pressure wave created by the activated weak detonating explosive across the cross-section of the first container.

38. A dispersing device as defined in claim 35, wherein the porous wad is consumed each time the pressure wave travels through the dispersing device.

39. A dispersing device as defined in claim 36, wherein the elastic film is consumed each time the pressure wave travels through the dispersing device.

40. A dispersing device as defined in claim 37, wherein at least one of the elastic film and the porous wad are consumed each time the pressure wave travels through the dispersing device.

41. A dispersing device as defined in claim 38, wherein at least one of the elastic film and the porous wad is replaceable.

42. A dispersing device as defined in claim 39, wherein at least one of the elastic film and the porous wad is replaceable.

43. A dispersing device as defined in claim 40, wherein at least one of the elastic film and the porous wad is replaceable.

44. A dispersing device as defined in claim 34, wherein the pressure wave created by the activated weak detonating explosive travels at a speed between about 1000 and about 3000 m/s.

45. A dispersing device as defined in claim 34, wherein the ratio of the weak detonating explosive to the physical agent is between about 1/50 and about 1/500.

46. A dispersing device as defined in claim 34, wherein the physical agent comprises a loose material.

47. A dispensing device as defined in claim 46, wherein the physical agent comprises at least one of powder, sand, snow, granular material and water.

48. A dispersing device as defined in claim 34, wherein the weak detonating explosive is contained in a replaceable cartridge having an igniter.

49. A dispersing device as defined in claim 34, wherein the pulse pulverization creates a pressure vortex at the exit side.

50. A method of spreading a pulse-pulverized physical agent while directing a dispersing device towards a surface intended to be covered by the pulse-pulverized physical agent, the method comprising utilizing the dispersing device, which comprises a container including a physical agent and a chamber having a weak detonating explosive connected by an interface, the weak detonating explosive adapted to provide, when activated, a pressure wave penetrating the physical agent to pulse-pulverize it and to force it through and out of an exit side of the container for spreading said pulse-pulverized physical agent while directing said dispersing device towards a surface intended to be covered by the pulse-pulverized physical agent.

51. A method as defined in claim 50, further comprising the step of activating the weak detonating explosive.

52. A method as defined in claim 50, further comprising the step of pointing the dispersing device toward said surface.

53. A method as defined in claim 50, wherein the surface is intended to be covered by the pulse-pulverized physical agent for camouflage, and the physical agent is an opaque agent.

54. A method as defined in claim 50, wherein the surface is intended to be covered by the pulse-pulverized physical agent for crowd control, and the physical agent contains at least one non-lethal incapacitant agent.

55. A method as defined in claim 49, wherein the physical agent contains at least one of tear gas, pepper spray, and sticky foam.

56. A method as defined in claim 50, wherein the surface is intended to be covered by the pulse-pulverized physical agent for treating water contamination by pulse-pulverizing and spreading the physical agent over a contaminated surface, and the physical agent comprises biosorbents adapted to at least one of break down and remove the contamination.

57. A method as defined in claim 56, wherein the physical agent comprises at least one of microorganisms and biological agents.

58. A method as defined in claim 50, wherein the surface is intended to be covered by the pulse-pulverized physical agent for treating radioactive soil contamination by pulse-pulverizing and spreading the physical agent over a contaminated surface, and the physical agent comprises radioactivity neutralizing particles.

59. A method as defined in claim 50, wherein the surface is intended to be covered by the pulse-pulverized physical agent for treating airborne radioactive contamination by pulse-pulverizing said physical agent at least one of over and inside a cloud of the airborne radioactive contamination, and the physical agent comprises radioactivity neutralizing particles.
